(19) United States
(12) Patent Application Publication
(10) Pub. No.: US 2012/0226619 A1
(43) Pub. Date: Sep. 6, 2012

(54) SYSTEM AND METHOD FOR PROVIDING AFTER-SALES SERVICE TO ELECTRONIC DEVICES VIA A MOBILE DEVICE

(75) Inventors: Hyung Taek RYOO, Suwon-si (KR); Jin Soo KIM, Namyangju-si (KR)

(73) Assignee: SAMSUNG ELECTRONICS CO. LTD., Suwon-si (KR)

(21) Appl. No.: 13/402,138

(22) Filed: Feb. 22, 2012

(30) Foreign Application Priority Data
Mar. 2, 2011 (KR) 10-2011-0018496

(51) Int. Cl. G06Q 10/00; G06F 11/14

(52) U.S. Cl. 705/304; 714/3; 714/E11.117

(57) ABSTRACT

A system and method for providing an After-Sale service (AS) to an electronic device via a mobile device are provided. The method includes receiving, by a mobile device, state information from the electronic device, transmitting, by the mobile device, the state information regarding the electronic device to a cloud server, determining, by the cloud server, whether the electronic device is experiencing a fault, via the received state information, determining, by the cloud server, whether the cloud server has fault fixing firmware for fixing the fault, transmitting, when the cloud server has the fault fixing firmware, the fault fixing firmware to the mobile device, transmitting, by the mobile device, the fault fixing firmware to the electronic device, and installing the fault fixing firmware in the electronic device.

### PRIORITY

This application claims the benefit under 35 U.S.C. §119(a) of a Korean patent application filed on Mar. 2, 2011 in the Korean Intellectual Property Office and assigned Serial No. 10-2011-0018496, the entire disclosure of which is hereby incorporated by reference.

### BACKGROUND OF THE INVENTION

1. Field of the Invention

This present invention relates to electronic device after-sales service systems. More particularly, the present invention relates to a system and method for providing after-sales service to electronic devices via a mobile device that can perform short-range communication.

2. Description of the Related Art

Electronic products used in daily life frequently do not function properly due to problems in the hardware or software. In that case, users typically contact a service center for the electronic product, and inform the staff member about the faulty product or else take the faulty product to the service center.

In a case where a user calls a call center and requests After-sales Service (AS), it takes the user a certain period time to connect the call center worker, explain the problems with the product, and provide the serial number. This inconveniences the user. In addition, the call center worker may not precisely detect the current state of the faulty product from the user's explanation.

When the problems with the electronic product are related to software, the user may repair the faults according to the call center worker's directions, without taking the faulty electronic product to the AS center or requesting a service appointment from a service engineer. However, when an electronic product is malfunctioning, the user may not be able to determine if the problem is related to software or hardware. Therefore, most users take the faulty electronic products to the service center or request a service appointment with the service engineer. This causes users to waste time.

### SUMMARY OF THE INVENTION

Aspects of the present invention are to address at least the above-mentioned problems and/or disadvantages and to provide at least the advantages described below. Accordingly, an aspect of the present invention is to provide a method for providing After-sales Service (AS) to electronic devices via a mobile device.

Another aspect of the present the invention is to provide a system adapted to the electronic device AS method.

In accordance with an exemplary embodiment of the invention, a method for providing an electronic device AS to an electronic device is provided. The method includes receiving, by a mobile device, state information from the electronic device, transmitting, by the mobile device, the state information regarding the electronic device to a cloud server, determining, by the cloud server, whether the electronic device is experiencing a fault, via the received state information, determining, by the cloud server, whether the cloud server has fault fixing firmware for fixing the fault, transmitting, when the cloud server has the fault fixing firmware, the fault fixing firmware to the mobile device, transmitting, by the mobile device, the fault fixing firmware to the electronic device, and installing the fault fixing firmware in the electronic device.

In accordance with another exemplary embodiment of the invention, a method for providing an AS to an electronic device is provided. The method includes receiving, by a mobile device, state information from the electronic device, transmitting, by the mobile device, the state information regarding the electronic device to an AS center, determining, by the AS center, whether the electronic device is experiencing a fault, via the received state information, determining, by the AS center, whether the electronic device has a software fault, transmitting, when the electronic device has a software fault, information regarding the fault to a cloud server, determining, by the cloud server, whether the cloud server has fault fixing firmware for fixing the fault, transmitting, when the cloud server has fault fixing firmware, the fault fixing firmware to the mobile device, transmitting, by the mobile device, the fault fixing firmware to the electronic device, and installing the fault fixing firmware in the electronic device.

In accordance with another exemplary embodiment of the invention, a system for providing an AS to an electronic device is provided. The system includes an electronic device with a short-range communication module, a mobile device, and a cloud server, wherein the electronic device communicates with the mobile device via short-range communication, collects state information, transmits the collected state information to the mobile device according to a request of the mobile device, receives fault fixing firmware from the mobile device, and installs the fault fixing firmware, wherein the mobile device receives the state information regarding the electronic device from the electronic device, transmits the state information to the cloud server, receives the fault fixing firmware from the cloud server, and transmits the received fault fixing firmware to the electronic device, and wherein the cloud server determines whether the electronic device is experience a fault, via the state information regarding the electronic device, determines whether the cloud server has the fault fixing firmware for fixing the fault of the electronic device, and transmits the fault fixing firmware to the mobile device.

In accordance with another exemplary embodiment of the invention, a method for providing an electronic device AS adapted to a mobile device is provided. The method includes receiving state information regarding the electronic device, transmitting the received state information from the mobile device to a cloud server, receiving fault fixing firmware from the cloud server, and displaying a message notifying that the fault fixing firmware has been received, receiving a user's instruction for transmitting the fault fixing firmware and determining whether the mobile device can communicate with the electronic device, and transmitting, when the mobile device can communicate with the electronic device, the fault fixing firmware to the electronic device.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a view illustrating a configuration of a system for providing After-sales Service (AS) to electronic devices via using via a mobile device, according to an exemplary embodiment of the present invention;

FIG. 2 is a schematic block diagram of a mobile device according to an exemplary embodiment of the present invention;

FIG. 3 is a schematic block diagram of an electronic device according to an exemplary embodiment of the present invention;

FIG. 4 is a schematic block diagram of a cloud server according to an exemplary embodiment of the present invention;

FIG. 5 is a schematic block diagram of an AS center according to an exemplary embodiment of the present invention;

FIG. 6 is a flowchart that describes a method for providing AS to electronic devices, according to an exemplary embodiment of the present invention;

FIG. 7 is a flowchart that describes a method for providing AS to electronic devices, according to another exemplary embodiment of the present invention;

FIG. 8 is a flowchart that describes operations of an electronic device in a system for providing AS, according to an exemplary embodiment of the present invention;

FIG. 9 is a flowchart that describes operations of a mobile device in a system for providing AS, according to an exemplary embodiment of the present invention;

FIG. 10 is a flowchart that describes operations of a cloud server in a system for providing AS, according to an exemplary embodiment of the present invention;

FIG. 11 is a flowchart that describes operations of an AS center in a system for providing AS, according to an exemplary embodiment of the present invention; and

FIG. 12 is a flowchart that describes operations of an AS center in a system for providing AS, according to another exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, it should be understood that a mobile device with a short-range communication module, can be applied to all information communication devices, multimedia devices, and their applications, for example, mobile communication terminals, Portable Multimedia Players (PMPs), Personal Digital Assistants (PDAs), smartphones, audio players, etc.

In an exemplary embodiment of the present invention, a short-range communication module installed to the mobile device may be a Near Field Communication (NFC) module, a Bluetooth module, a Wi-Fi module, a ZigBee module, an Infra-red communication module, a Radio Frequency Identification (RFID) module, etc. For the sake of convenience, the short-range communication module is described herein based on an NFC module.

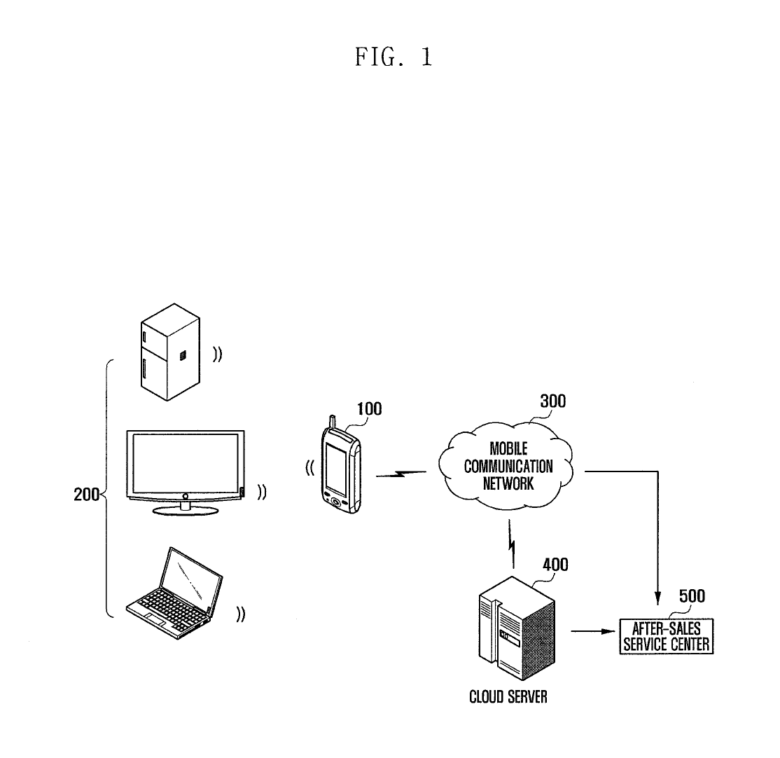

FIG. 1 is a view illustrating a configuration of a system for providing After-sales Service (AS) to electronic devices via a mobile device, according to an exemplary embodiment of the present invention.

The electronic device AS system includes a mobile device 100, electronic devices 200, a mobile communication network 300, a cloud server 400, and an AS center 500.

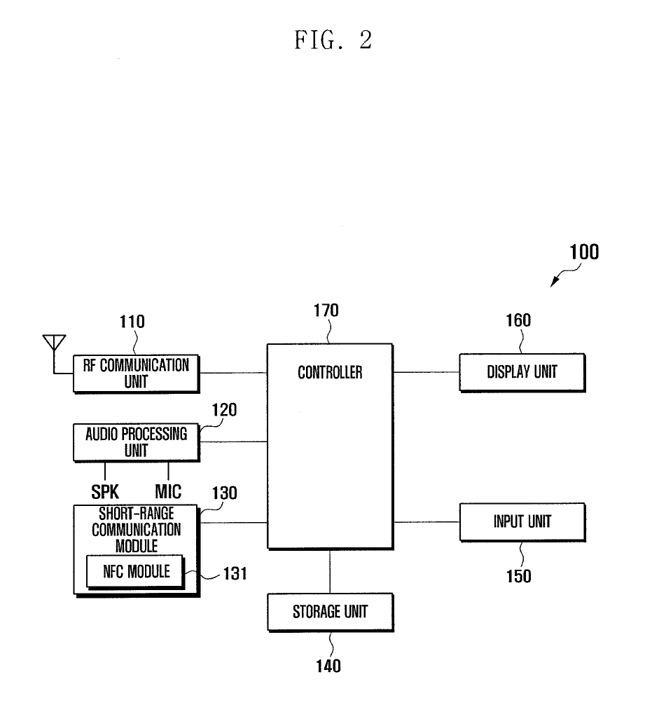

The mobile device 100 refers to devices that users can carry. The mobile device 100 includes an NFC module, and a Radio Frequency (RF) communication module and/or Wi-Fi module. The NFC module reads information from an NFC tag fixed to the electronic devices 200. The RF communication module and/or Wi-Fi module is connected to the mobile communication network 300. The configuration of the mobile device 100 will be described in detail, later, referring to FIG. 2.

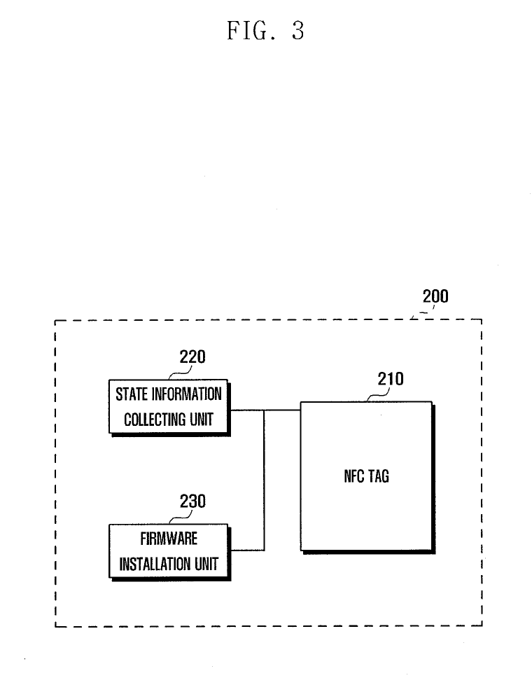

The electronic devices 200 refer to appliances, such as refrigerators, TeleVision (TV) sets, computers, etc. The electronic devices 200 include NFC tags, respectively. The electronic devices 200 transmit the state information to the mobile device 100 via the NFC tags, respectively. The electronic devices 200 can receive firmware for fixing a fault from the mobile device 100. The configuration of the electronic devices 200 will be described in detail, later, referring to FIG. 3.

The mobile communication network 300 connects the mobile device 100 to the cloud server 400 or the AS center 500. The mobile communication network 300 may be implemented with networks that can support Time Division Multiple Access (TDMA), Frequency Division Multiple Access (FDMA), Code Division Multiple Access (CDMA), Universal Mobile Telecommunications System (UMTS), Global System for Mobile Communication (GSM), etc. The mobile communication network 300 may also be implemented with wireless Internet.

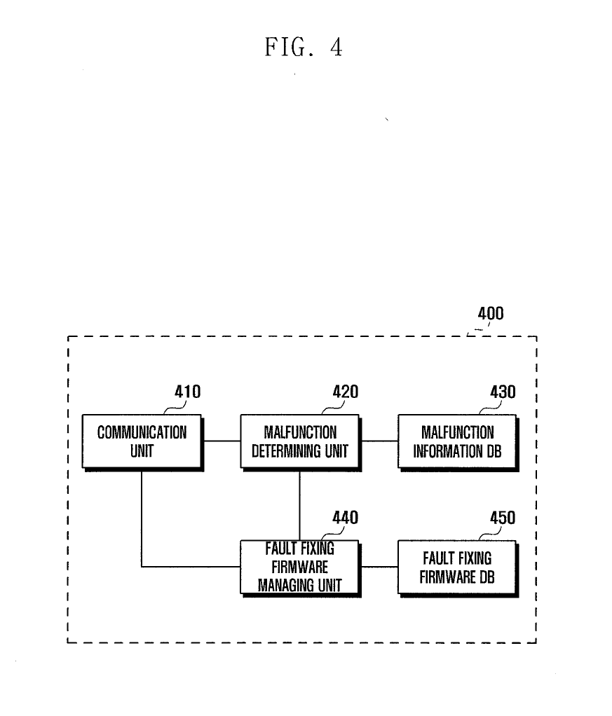

The cloud server 400 refers to a server associated with a manufacturer of the electronic devices 200. The cloud server 400 communicates with the mobile device 100 via the mobile communication network 300. The cloud server 400 receives state information regarding the electronic devices 200 from the mobile device 100, and transmits firmware for fixing a fault to the mobile device 100. The configuration of the cloud server 400 will be described in detail, later, referring to FIG. 4.

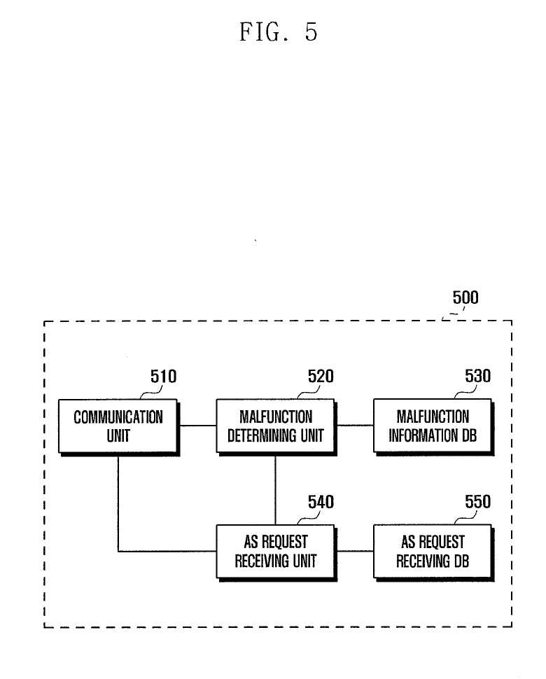

The AS center 500 refers to a center associated with a manufacturer of the electronic devices 200. The AS center 500 communicates with the cloud server 400 or directly communicates with the mobile device 100 via the mobile communication network 300. The AS center 500 processes AS requests. When the AS center 500 receives information regarding a fault of an electronic device 200 from the cloud server 400 or the mobile device 100, the AS center 500 provides available appointment times to the mobile device 100. When the AS center 500 receives one of the available appointment times that the user has selected from the mobile device 100, the AS center 500 accepts the AS request at the selected time. The configuration of the AS center 500 will be described in detail, later, referring to FIG. 5.

FIG. 2 is a schematic block diagram of a mobile device according to an exemplary embodiment of the present invention.

The mobile device 100 includes an RF communication unit 110, an audio processing unit 120, a short-range communication module 130, a storage unit 140, an input unit 150, a display unit 160, and a controller 170.

The RF communication unit 110 transmits/receives wireless communication data for the mobile device 100 to/from external systems. The RF communication unit 110 includes an RF transmitter for up-converting the frequency of signals to be transmitted and for amplifying the signals and an RF receiver for low-noise amplifying received RF signals and for down-converting the frequency of the received RF signals. The RF communication unit 110 receives data via a wireless channel and outputs the received data to the controller 170. The RF communication unit 110 also transmits data, output from the controller 170, via the wireless channel. In an exemplary embodiment of the present invention, the RF communication unit 110 receives firmware for fixing a fault of the electronic devices 200 from the cloud server 400 and outputs the firmware to the controller 170. 1 The audio processing unit 120 includes CODers and DECoders (CODECs). The CODECs are comprised of a data CODEC for processing packet data, etc., and an audio CODEC for processing audio signals, such as voice signals, etc. The audio CODEC converts digital audio signals into analog audio signals and outputs the analog audio signals via a SPeaKer (SPK). The audio CODEC also converts analog audio signals, received via a MICrophone (MIC), into digital audio signals.

The short-range communication module 130 performs short-range communication with the electronic devices 200 in a limited coverage area. In an exemplary embodiment of the present invention, the short-range communication module 130 includes an NFC module 131. It should be, however, understood that the invention is not limited to the exemplary embodiment described herein. For example, the short-range communication module 130 may also include a Wi-Fi module, a Bluetooth module, a ZigBee module, an RFID module, etc.

The NFC module 131 performs near field communication with an NFC tag fixed to the electronic device 200. The NFC module 131 transmits a signal to the electronic device 200 for requesting state information thereof. When the NFC module 131 receives the state information from the electronic device 200, the NFC module 131 transfers the state information to the controller 170. The NFC module 131 receives fault fixing firmware and an instruction for transmitting the fault fixing firmware from the controller 170, and transmits the fault fixing firmware to the electronic device 200.

The storage unit 140 stores programs used to operate the mobile device 100 and data generated when the programs are executed. The storage unit 140 may be comprised of a program storage area and a data storage area. The program storage area stores a program for controlling operations of the mobile device 100 and an Operating System (OS) for booting the mobile device 100. The program storage area also stores an application program for playing back multi-media contents, and the other application programs that are used for optional functions, such as a camera function, an audio playback function, an image or video playback function, etc. The data storage area stores data generated when the mobile device 100 is used, such as images, video, phone book, audio data, etc. In an exemplary embodiment of the present invention, the storage unit 140 stores the firmware for fixing faults of the electronic devices 200, received via the RF communication unit 110.

The input unit 150 receives a user's operated key signals for controlling the mobile device 100 and transfers the key signals to the controller 170. The input unit 150 can be implemented with various types of keypads including numerical keys, alphabetical keys, and directional keys, for example a 3×4 keypad, a QWERTY keypad, a touch pad, etc. The input unit 150 may also include a button key, a jog key, a wheel key, etc. The input unit 150 creates signals for executing applications of the mobile device 100 according to a user's input, and transfers the signals to the controller 170. Examples of the applications are a call function application, an audio playback application, a video playback application, an image displaying application, a camera photographing application, a Digital Multimedia Broadcasting (DMB) broadcast playback application, etc.

The display unit 160 may be implemented with a Liquid Crystal Display (LCD), an Organic Light Emitting Diode (OLED), an Active Matrix Organic Light Emitting Diodes (AMOLED), or the like. The display unit 160 displays menus, input data, function-setting information, and additional information. For example, the display unit 160 displays a booting screen, an idle screen, a call screen, and application executing screens of the mobile device.

The controller 170 controls the operations of the components in the mobile device 100. The controller 170 executes electronic device AS applications according to a user's instructions. The controller 170 controls the NFC module 131 to transmit a signal for requesting state information. When the mobile device 100 approaches the electronic device 200, the electronic device 200 receives a state information request signal via the NFC tag and transmits the response signal containing the state information to the mobile device 100. The controller 170 receives the state information regarding the electronic device 200 via the NFC module 131. The controller 170 transmits the state information to the cloud server 400 or AS center 500 via the RF communication unit 110. Alternatively, when the controller 170 receives the state information from the electronic device 200, the controller 170 may control the display unit 160 to display a menu asking the user whether to transmit the state information to the cloud server 400 or AS center 500. After that, the controller 170 controls the RF communication unit 110 to transmit the state information based on the user's selection.

The controller 170 receives firmware for fixing the fault from the cloud server 400 via the RF communication unit 110, and controls the display unit 160 to display a message stating that the fault fixing firmware has been received. When the controller 170 receives an instruction for transmitting fault fixing firmware from the input unit 150, the controller 170 determines whether the mobile device 100 can communicate with the electronic device 200 via the NFC module 131. When the controller 170 determines that the mobile device 100 can communicate with the electronic device 200 via the NFC module 131, the controller 170 controls to transmit the firmware to the electronic device 200. In contrast, when the controller 170 determines that the mobile device 100 cannot communicate with the electronic device 200, the controller 170 controls the display unit 160 to display a transmission failure message.

The controller 170 receives available service appointment times from the AS center 500 via the RF communication unit 110, and controls the display unit 160 to display the available service appointment times. When the controller 170 receives a user's selected book time via the input unit 150, the controller 170 controls the RF communication unit 110 to transmit the user's selected book time to the AS center. The controller 170 receives a message confirming that a service appointment has been made from the AS center 500.

In an exemplary embodiment of the present invention, the mobile device 100 may further include an additional component such as a Bluetooth module, a Wi-Fi module, a Universal Serial Bus (USB) module, or the like. In that case, the controller 170 can transmit the fault fixing firmware to the electronic devices 200 via the additional component.

FIG. 3 is a schematic block diagram of an electronic device according to an exemplary embodiment of the present invention.

The electronic device 200 includes an NFC tag 210, a state information collecting unit 220, and a firmware installation unit 230.

The NFC tag 210 performs NFC communication with the NFC module 131 of the mobile device 100. The NFC tag 210 receives a signal from the NFC module 131, creates the response signal and transmits the response signal thereto. In an exemplary embodiment of the present invention, the NFC tag 210 transmits the state information regarding the electronic device 200 to the NFC module 131, and receives firmware for fixing the fault therefrom. The NFC tag 210 stores basic information regarding the electronic device 200, such as the type code, model type, serial number, manufacture data, etc. In addition, the NFC tag 210 may also store a Uniform Resource Locator (URL) of the cloud server 400 to be connected or the phone number of the AS center 500. The NFC tag 210 may transmit, to the NFC module 131, the state information regarding the electronic device 200 together with the basic information regarding the electronic device 200, the URL of the cloud server 400, and/or the phone number of the AS center 500.

The state information collecting unit 220 collects the current state information regarding the electronic device 200. In an exemplary embodiment of the present invention, the state information may be at least one of a drive voltage value, General Purpose Input/Output (GPIO) value, a debugging log, an error code, etc.

The drive voltage value refers to a voltage value controlled by a Power Management Integrated Chip (PMIC) included in the electronic device 200. The GPIO value refers to a low/high logic value of the GPIO pin of a processor included in the electronic device 200. The debugging log refers to a log regarding error or correction of a program when the electronic device 200 is in a low level state. The error code refers to an error code that occurred in the electronic device 200.

When the NFC tag 210 notifies the state information collecting unit 220 that a state information request signal has been received, the state information collecting unit 220 collects state information, such as, at least one of a drive voltage value, a GPIO value, a debugging log, an error code, etc., and transmits the state information to the NFC tag 210. In an exemplary embodiment of the present invention, the state information collecting unit 220 periodically collects information regarding the electronic device 200 and stores the information in the NFC tag 210.

The firmware installation unit 230 installs firmware for fixing the faulty states of the electronic device 200 transmitted from the NFC tag 210. The fault fixing firmware may include identification information of the electronic devices that can be applied thereto. The firmware installation unit 230 detects the identification information regarding the electronic device 200 in the received fault fixing firmware and determines whether the firmware can be applied to fixing the fault. When the firmware installation unit 230 determines that the firmware can be applied to fixing the fault, the firmware installation unit 230 installs the received firmware.

In an exemplary embodiment of the present invention, the electronic device 200 may further include an additional component, such as a Bluetooth module, a Wi-Fi module, a USB module, or the like. In that case, the firmware installation unit 230 can receive the fault fixing firmware from the mobile device 100 via the additional component.

FIG. 4 is a schematic block diagram of a cloud server according to an exemplary embodiment of the present invention.

The cloud server 400 includes a communication unit 410, a malfunction determining unit 420, a malfunction information DataBase (DB) 430, a fault fixing firmware managing unit 440, and a fault fixing firmware DB 450.

The communication unit 410 performs communication, via a wired/wireless network, with the mobile device 100 and the AS center 500. The communication unit 410 receives the state information regarding the electronic device 200 from the mobile device 100, and transmits fault fixing firmware thereto. The communication unit 410 also transmits the fault information regarding the electronic device 200 to the AS center 500. In an exemplary embodiment of the present invention, the communication unit 410 can receive the fault information regarding the electronic device 200 from the AS center 500, and transmit a message to the AS center 500 indicating that the server 400 does not have fault fixing firmware.

The malfunction determining unit 420 determines whether the electronic device 200 is faulty, based on the state information regarding the electronic device 200 transmitted from the mobile device 100.

The malfunction information DB 430 stores fault information corresponding to the state information regarding the electronic device 200. The malfunction information DB 430 can store at least one of drive voltage values, GPIO values, etc., corresponding to the normal states of the electronic devices 200, respectively.

The malfunction determining unit 420 detects types of the electronic device 200 via the information transmitted from the mobile device 100. The malfunction determining unit 420 compares the state information regarding the detected type of electronic device with information when the detected type of electronic device is in a normal state, stored in the malfunction information DB 430. When the malfunction determining unit 420 determines that the state information regarding the detected type of electronic device is identical to the normal state information, the malfunction determining unit 420 concludes that the electronic device 200 does not have a hardware fault.

In contrast, when the malfunction determining unit 420 determines that the state information regarding the detected type of electronic device is not identical to the normal state information, the malfunction determining unit 420 concludes that the electronic device 200 has a hardware fault. In that case, the malfunction determining unit 420 controls the communication unit 410 to transmit the fault information regarding the electronic device 200 to the AS center 500. The fault information may also include information indicating that the electronic device 200 has a hardware fault, and the state information such as at least one of a drive voltage value, a GPIO value, etc.

The malfunction determining unit 420 detects at least one of a debugging log and an error code from the state information regarding the electronic device 200, and determines whether the electronic device 200 has a software fault. When the state information has at least one of an error code and a debugging log that includes error correction failure information, the malfunction determining unit 420 concludes that the electronic device 200 has a software fault. When the malfunction determining unit 420 concludes that the electronic device 200 has no faults with its hardware and software, the malfunction determining unit 420 can transmit a message indicating that there is no fault in the electronic device 200, to the mobile device 100, via the communication unit 410.

When the malfunction determining unit 420 concludes that the electronic device 200 has a software fault, the malfunction determining unit 420 transmits the fault information, such as an error code or error information, to the fault fixing firmware managing unit 440.

The fault fixing firmware managing unit 440 receives the fault information regarding the electronic device 200 from the malfunction determining unit 420, extracts fault fixing firmware corresponding to the fault information from the fault fixing firmware DB 450, and transmits the fault fixing firmware to the mobile device 100 via the communication unit 410. The fault fixing firmware DB 450 stores fault fixing firmware corresponding to respective error codes and error information. The fault fixing firmware managing unit 440 detects the fault information transmitted from the malfunction determining unit 420, and determines whether corresponding fault fixing firmware is stored in the fault fixing firmware DB 450. When the fault fixing firmware managing unit 440 determines that corresponding fault fixing firmware is stored in the fault fixing firmware DB 450, the fault fixing firmware managing unit 440 transmits the corresponding fault fixing firmware to the mobile device 100 via the communication unit 410. In contrast, when the fault fixing firmware managing unit 440 determines that corresponding fault fixing firmware is not stored in the fault fixing firmware DB 450, the fault fixing firmware managing unit 440 transmits the fault information to the AS center 500 via the communication unit 410. The fault information may include an error code, error information, etc. When the electronic device 200 has a software fault, the fault may further include information indicating that the electronic device 200 has a software fault.

FIG. 5 is a schematic block diagram of an AS center according to an exemplary embodiment of the present invention.

The AS center 500 includes a communication unit 510, a malfunction determining unit 520, a malfunction information DB 530, an AS request receiving unit 540, and an AS request receiving DB 550.

The communication unit 510 performs communication, via a wired/wireless network, with the mobile device 100 and the cloud server 400. The communication unit 510 receives state information regarding the electronic device 200 from the mobile device 100 via an Multimedia Message Service (MMS) message, etc., and transmits available service appointment times thereto. In addition, the communication unit 510 transmits fault information regarding the electronic device 200 to the cloud server 400, and receives a signal indicating that the cloud server 400 does not have fault fixing firmware, from the cloud server 400. In that case, the communication unit 510 notifies the AS request receiving unit 540 that the cloud server 400 does not have fault fixing firmware. The communication unit 510 receives the fault information regarding the electronic device 200 from the cloud server 400.

The malfunction determining unit 520 determines whether the electronic device 200 is faulty, based on the state information regarding the electronic device 200 transmitted from the mobile device 100.

The malfunction information DB 530 stores fault information corresponding to the state information regarding the electronic device 200. The malfunction information DB 530 can store at least one of drive voltage values, GPIO values, etc., corresponding to the normal states of the electronic devices 200, respectively.

The malfunction determining unit 520 detects types of the electronic device 200 via the information transmitted from the mobile device 100. The malfunction determining unit 520 compares the state information regarding the detected type of electronic device with information when the detected type of electronic device is in a normal state, stored in the malfunction information DB 530. When the malfunction determining unit 520 determines that the state information regarding the detected type of electronic device is identical to the normal state information, the malfunction determining unit 520 concludes that the electronic device 200 does not have a hardware fault.

In contrast, when the malfunction determining unit 520 determines that the state information regarding the detected type of electronic device is not identical to the normal state information, the malfunction determining unit 520 concludes that the electronic device 200 has a hardware fault. In that case, the malfunction determining unit 520 transmits the fault information regarding the electronic device 200 to the AS request receiving unit 540.

The malfunction determining unit 520 detects at least one of a debugging log and an error code from the state information regarding the electronic device 200, and determines whether the electronic device 200 has a software fault. When the state information has at least one of an error code and a debugging log that includes error correction failure information, the malfunction determining unit 520 concludes that the electronic device 200 has a software fault. When the malfunction determining unit 520 concludes that the electronic device 200 has no faults with its hardware and software, the malfunction determining unit 520 can transmit a message indicating that there is no fault in the electronic device 200, to the mobile device 100, via the communication unit 510.

When the malfunction determining unit 520 concludes that the electronic device 200 has a software fault, the malfunction determining unit 520 transmits the fault information, such as an error code or error information, to the cloud server 400, via the communication unit 510.

The AS request receiving unit 540 receives the AS request of the electronic device 200. The AS request receiving DB 550 stores information regarding the AS schedule. The AS request receiving unit 540 detects available service appointment times via the AS request receiving DB 550, and transmits a message including the available service appointment times to the mobile device 100 via the communication unit 510. When the AS request receiving unit 540 receives fault information regarding the electronic device 200 from the malfunction determining unit 520, the AS request receiving unit 540 searches for available service appointment times from the AS request receiving DB 550 and transmits a message including the available service appointment times to the mobile device 100 via the communication unit 510. When the AS request receiving unit 540 receives the selected service appointment time from the mobile device 100 via the communication unit 510, the AS request receiving unit 540 registers the time in the AS request receiving DB 550 and transmits a message that a service appointment has been made to the mobile device 100 via the communication unit 510.

In an exemplary embodiment of the present invention, when the AS request receiving unit 540 receives the fault information regarding the electronic device 200 from the cloud server 400 via the communication unit 510, the AS request receiving unit 540 searches for available service appointment times from the AS request receiving DB 550 and transmits a message including the available service appointment times to the mobile device 100 via the communication unit 510. In addition, when the AS request receiving unit 540 receives the selected service appointment time from the mobile device 100 via the communication unit 510, the AS request receiving unit 540 registers the selected service appointment time in the AS request receiving DB 550 and transmits a message confirming that a service appointment has been made to the mobile device 100 via the communication unit 510.

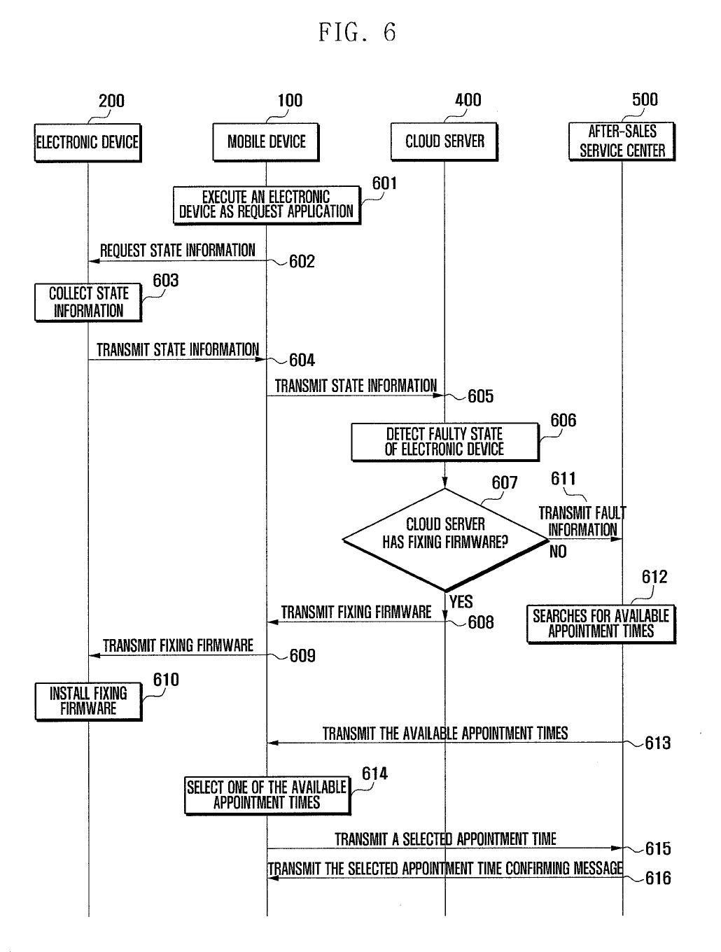

FIG. 6 is a flowchart that describes a method for providing AS to electronic devices, according to an exemplary embodiment of the present invention.

The mobile device 100 executes an electronic device AS request application in step 601, and transmits a state information request signal via the NFC module 131 in step 602. When the mobile device 100 approaches the electronic device 200, the electronic device 200 receives the state information request signal from the mobile device 100. The electronic device 200 collects the state information according to the received request signal in step 603. The state information regarding the electronic device 200 may be at least one of a drive voltage value, a GPIO value, a debugging log, an error code, etc. In an exemplary embodiment of the present invention, the electronic device 200 can periodically collect the state information before receiving the state information request signal from the mobile device 100. The electronic device 200 transmits the state information to the mobile device 100 in step 604. The mobile device 100 transmits the received state information regarding the electronic device 200 to the cloud server 400 in step 605.

The cloud server 400 determines whether the electronic device 200 is faulty, based on the state information regarding the electronic device 200 transmitted from the mobile device 100 in step 606. That is, the cloud server 400 determines whether the electronic device 200 has a hardware fault, using at least one of the drive voltage value, GPIO value, etc. The cloud server 400 also determines whether the electronic device 200 has a software fault, using at least one of the debugging log, error code, etc.

After that, the cloud server 400 determines whether it has fault fixing firmware in step 607. The cloud server 400 may conclude that the electronic device 200 has a hardware or software fault or a fault involving both hardware and software.

When the cloud server 400 concludes that the electronic device 200 has a software fault, the cloud server 400 determines whether it has firmware for fixing the corresponding software. When the cloud server 400 determines that it has fault fixing firmware, the cloud server 400 transmits the fault fixing firmware to the mobile device 100 in step 608. The mobile device 100 transmits the fault fixing firmware to the electronic device 200 via NFC communication in step 609. The electronic device 200 installs the received fault fixing firmware in step 610. In another exemplary embodiment of the present invention, when the mobile device 100 and electronic device 200 each include a Bluetooth module or a Wi-Fi module, the mobile device 100 may transmit the fault fixing firmware to the electronic device 200 via Bluetooth communication or Wi-Fi communication at step 609. In another exemplary embodiment of the present invention, the cloud server 400 may also transmit, to the mobile device 100, fixing information according to faulty states, when transmitting the fault fixing firmware.

Meanwhile, when the cloud server 400 concludes that the electronic device 200 has a hardware fault or that it does not have firmware for fixing a software fault at 607, the cloud server 400 transmits the fault information regarding the electronic device 200 to the AS center 500 in step 611. The AS center 500 searches for available service appointment times from the AS request receiving DB 550 in step 612, and transmits the available service appointment times to the mobile device 100 in step 613. The mobile device 100 displays the received available service appointment times. When the user selects one of the available service appointment times, as a selected service appointment time, the mobile device 100 receives the selected service appointment time in step 614, and transmits the selected service appointment time to the AS center 500 in step 615. The AS center 500 transmits a message, confirming that a service appointment has been made, to the mobile device 100 in step 616. The mobile device 100 displays the message on the display unit.

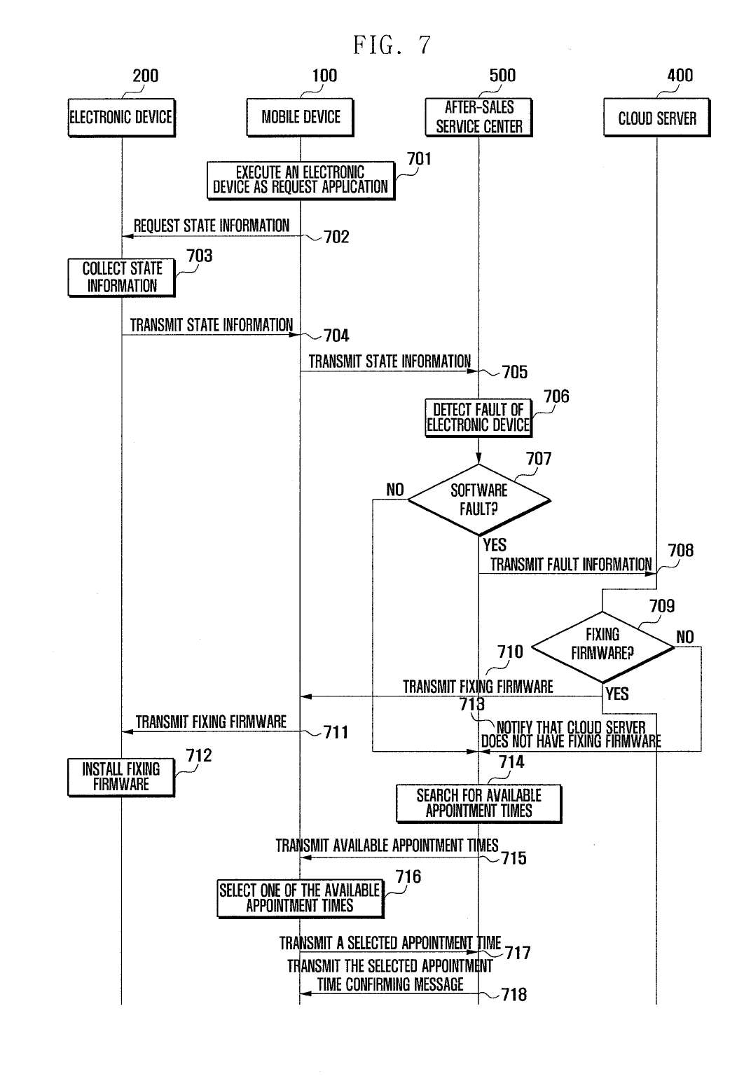

FIG. 7 is a flowchart that describes a method for providing AS to electronic devices, according to an exemplary embodiment of the present invention.

The mobile device 100 executes an electronic device AS request application in step 701, and transmits a state information request signal via the NFC module 131 in step 702. When the electronic device 200 receives the state information request signal from the mobile device 100, the electronic device 200 collects the state information in step 703. The state information regarding the electronic device 200 may be at least one of a drive voltage value, a GPIO value, a debugging log, an error code, etc. In an exemplary embodiment of the present invention, the electronic device 200 can periodically collect the state information before receiving the state information request signal from the mobile device 100. The electronic device 200 transmits the state information to the mobile device 100 in step 704. The mobile device 100 transmits the received state information regarding the electronic device 200 to the AS center 500 in step 705.

The AS center 500 determines whether the electronic device 200 is faulty, based on the state information regarding the electronic device 200 transmitted from the mobile device 100 in step 706. That is, the AS center 500 may determine whether the electronic device 200 has a hardware fault, using at least one of the drive voltage value, GPIO value, etc. The AS center 500 may determine whether the electronic device 200 has a software fault, via at least one of a debugging log, an error code, etc.

After that, the AS center 500 determines whether the electronic device 200 has a software fault in step 707. The AS center 500 may conclude that the electronic device 200 has a hardware or software fault or faults involving both hardware and software.

When the AS center 500 determines that the electronic device 200 has a software fault, the AS center 500 transmits the fault information regarding the electronic device 200 to the cloud server 400 in step 708. The fault information may include at least one of an error code and error information, as software fault information.

When the cloud server 400 receives the fault information regarding the electronic device 200 from the AS center 500, the cloud server 400 determines whether it has firmware for fixing the fault in step 709. When the cloud server 400 determines that it has fault fixing firmware at step 709, the cloud server 400 transmits the fault fixing firmware to the mobile device 100 in step 710. The mobile device 100 transmits the fault fixing firmware to the electronic device 200 via NFC communication in step 711. The electronic device 200 installs the received fault fixing firmware in step 712. In another exemplary embodiment of the present invention, when the mobile device 100 and electronic device 200 each include a Bluetooth module and/or a Wi-Fi module, the mobile device 100 may transmit the fault fixing firmware to the electronic device 200 via Bluetooth communication and/or Wi-Fi communication at step 711.

Meanwhile, when the AS center 500 concludes that the electronic device 200 does not have a software fault at step 707, the AS center 500 searches for available service appointment times in step 714. Alternatively, in another exemplary embodiment of the present invention, the AS center 500 may determine whether the electronic device 200 has a hardware fault at step 707. When the AS center 500 concludes that the electronic device 200 has a hardware fault, it searched for available service appointment times at step 714. In contrast, when the AS center 500 concludes that the electronic device 200 does not have a hardware fault, the AS center 500 transmits the fault information regarding the electronic device 200 to the cloud server 400 in step 708.

When the cloud server 400 determines that it does not have fault fixing firmware at step 709, the cloud server 400 notifies the AS center 500 that the cloud server 400 does not have fault fixing firmware in step 713. In that case, the AS center 500 searches for available service appointment times in step 714.

After that, the AS center 500 transmits the available service appointment times to the mobile device 100 in step 715. The mobile device 100 displays the received available service appointment times. When the user selects one of the available service appointment times, as a selected service appointment time, the mobile device 100 receives the selected service appointment time in step 716, and transmits the selected service appointment time to the AS center 500 in step 717. The AS center 500 transmits a message confirming that a service appointment has been made to the mobile device 100 in step 718. The mobile device 100 displays the message on the display unit.

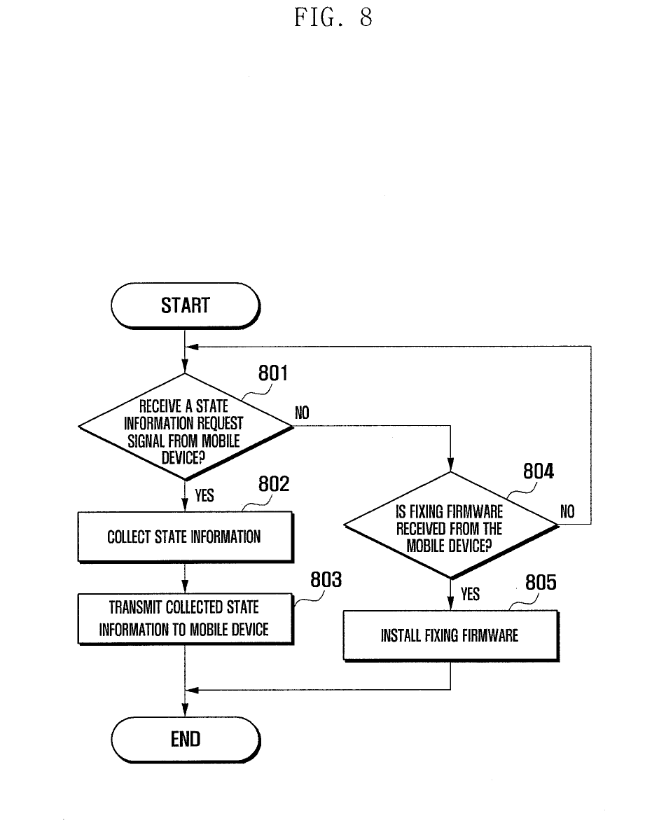

FIG. 8 is a flowchart that describes operations of an electronic device in a system for providing AS, according to an exemplary embodiment of the present invention.

The electronic device 200 determines whether the NFC tag 210 receives a state information request signal from the mobile device 100 in step 801. When the NFC tag 210 receives the signal for requesting the state information regarding the electronic device 200 at step 801, the NFC tag 210 notifies the state information collecting unit 220 that the NFC tag 210 has received the request signal. The state information collecting unit 220 collects the state information regarding the electronic device 200 in step 802. In an exemplary embodiment of the present invention, the state information may be at least one of a drive voltage value, a GPIO value, a debugging log, an error code, etc. The drive voltage value refers to a voltage value controlled by a PMIC included in the electronic device 200. The GPIO value refers to a low/high logic value of the GPIO pin of a processor included in the electronic device 200. The debugging log refers to a log regarding error or correction of a program when the electronic device 200 is in a low level state. The error code refers to an error code that occurred in the electronic device 200.

After collecting the state information at step 802, the state information collecting unit 220 transmits the state information to the NFC tag 210. The NFC tag 210 transmits the state information to the mobile device 100 in step 803. In an exemplary embodiment of the present invention, the state information collecting unit 220 can periodically collect the state information regarding the electronic device 200, and store the state information in the NFC tag 210. When the NFC tag 210 receives a state information request signal from the mobile device 100, the NFC tag 210 transmits the stored state information regarding the electronic device 200 to the mobile device 100. The NFC tag 210 may store basic information regarding the electronic device, such as at least one of a code corresponding to a type, a model name, a serial number, a manufacture date, etc. The NFC tag 210 may also store at least one of a URL of the cloud server to be connected and phone numbers of AS centers. At step 803, the NFC tag 210 may transmit the state information regarding the electronic device 200 to the mobile device 100, together with at least one of the basic information regarding the electronic device 200, the URL of a cloud server to be connected, and the phone numbers of AS centers.

In contrast, when the NFC tag 210 does not receive the signal for requesting the state information regarding the electronic device 200 at step 801, the electronic device 200 determines whether the NFC tag 210 receives fault fixing firmware from the mobile device 100 in step 804. When the NFC tag 210 receives fault fixing firmware from the mobile device 100 at step 804, the NFC tag 210 transmits the fault fixing firmware to the firmware installation unit 230. The firmware installation unit 230 installs the received fault fixing firmware in step 805. The fault fixing firmware includes identification information regarding the electronic devices. The firmware installation unit 230 identifies whether the identification information regarding the electronic devices can be supported by the fault fixing firmware. After determining that the identification information regarding the electronic devices can be supported by the fault fixing firmware, the firmware installation unit 230 installs the firmware. In contrast, when the electronic device 200 determines that the NFC tag 210 does not receive fault fixing firmware from the mobile device 100 at step 804, the electronic device 200 returns to and proceeds with step 801.

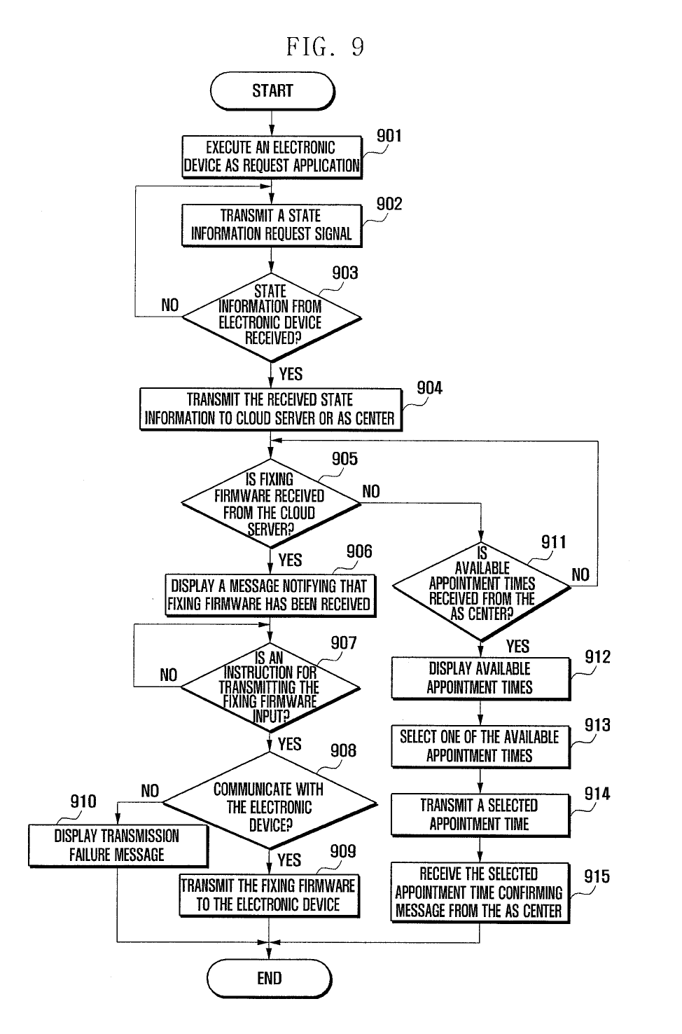

FIG. 9 is a flowchart that describes operations of a mobile device in a system for providing AS, according to an exemplary embodiment of the present invention.

The controller 170 of the mobile device 100 executes an electronic device AS request application according to a user's input in step 901. In an exemplary embodiment of the present invention, the electronic device AS request application at least one of checks whether the electronic device 200 is faulty, executes an AS request, and downloads a firmware for fixing errors. After executing an electronic device AS request application, the controller 170 controls the NFC module 131 to transmit a state information request signal in step 902. When the mobile device 100 approaches the electronic device 200 requested for checking the fault, the electronic device 200 receives the state information request signal from the mobile device 100 via the NFC tag, and the electronic device 200 transmits the response signal, including the state information, to the mobile device 100. In addition, the electronic device 200 may also transmit the basic information, such as at least one of a code corresponding to a type, a model name, a serial number, a manufacture date, etc., and at least one of a URL of the cloud server to be connected and phone numbers of AS centers.

The controller 170 determines whether the NFC module 131 receives the state information regarding the electronic device 200 from the electronic device 200 in step 903. When the controller 170 determines that the NFC module 131 receives the state information from the electronic device 200 at step 903, the controller 170 transmits the state information to the cloud server 400 or AS center 500 via the RF communication unit 110 in step 904. For example, when the controller 170 receives a URL of the cloud server 400 to be connected from the electronic device 200, the controller 170 transmits the state information to the cloud server 400 via the RF communication unit 110. Likewise, when the controller 170 receives phone numbers of AS centers from the electronic device 200, the controller 170 creates an MMS message including the state information regarding the electronic device 200, and transmits the MMS message to an AS center corresponding to a phone number, via the RF communication unit 110.

When the controller 170 receives a URL of the cloud server 400 to be connected and phone numbers of AS centers from the electronic device 200, the controller 170 controls the display unit 160 to display a menu asking the user to select which of the cloud server 400 or the AS center 500 the state information is to be transmitted to. When the user selects one of the cloud server 400 and the AS center 500, the controller 170 transmits the state information regarding the electronic device 200 according to user's selection. Alternatively, the controller 170 can transmit the state information to both the cloud server 400 and the AS center 500. In addition, the controller 170 can also transmit the state information to one of the cloud server 400 and the AS center 500, which has the higher priority than the other.

The controller 170 determines whether the mobile device 100 receives firmware for fixing the fault from the cloud server 400 via the RF communication unit 110 in step 905. When the electronic device 200 has a software fault, the mobile device 100 may receive fault fixing firmware from the cloud server 400. When the controller 170 determines that the mobile device 100 receives fault fixing firmware at step 905, the controller 170 controls the display unit 160 to display a message stating that fault fixing firmware has been received in step 906. The message may also include another message asking whether the user transmits the fault fixing firmware.

The controller 170 determines whether an instruction for transmitting the fault fixing firmware is input to the input unit 150 in step 907. When the controller 170 determines that an instruction for transmitting the fault fixing firmware is input to the input unit 150 at step 907, the controller 170 determines whether the mobile device 100 can communicate with the electronic device 200 via the NFC module 131 in step 908. When the controller 170 determines that the mobile device 100 can communicate with the electronic device 200 via the NFC module 131 at step 908, the controller 170 transmits the fault fixing firmware to the electronic device 200 in step 909. In contrast, when the controller 170 determines that the mobile device 100 cannot communicate with the electronic device 200 via the NFC module 131 at step 908, the controller 170 controls the display unit 160 to display a transmission failure message in step 910.

In an exemplary embodiment of the present invention, the mobile device 100 may further include an additional component, such as a Bluetooth module, a Wi-Fi module or a USB module. In that case, the controller 170 may determine whether the mobile device 100 can communicate with the electronic device 200 via the additional component at step 908. When the controller 170 determines that the mobile device 100 can communicate with the electronic device 200 via the additional component at step 908, the controller 170 can transmit the fault fixing firmware to the electronic device 200 via the additional component at step 909.

Meanwhile, when the controller 170 determines that the mobile device 100 did not receive fault fixing firmware from the cloud server 400 at step 905, the controller 170 determines whether the mobile device 100 receives available service appointment times from the AS center 500 via the RF communication unit 110 in step 911. When the controller 170 determines that the mobile device 100 receives available service appointment times from the AS center 500 at step 911, the controller 170 controls the display unit 160 to display the available service appointment times in step 912. The user can select one of the available service appointment times, as a selected service appointment time, via the input unit 150. When the controller 170 receives a user's selected service appointment time in step 913, the controller 170 transmits the selected service appointment time to the AS center 500 in step 914. After that, the mobile device 100 receives the message confirming that a service appointment has been made from the AS center 500 in step 915. In contrast, when the controller 170 determines that the mobile device 100 does not receive available service appointment times from the AS center 500 at step 911, the controller 170 returns to step 905.

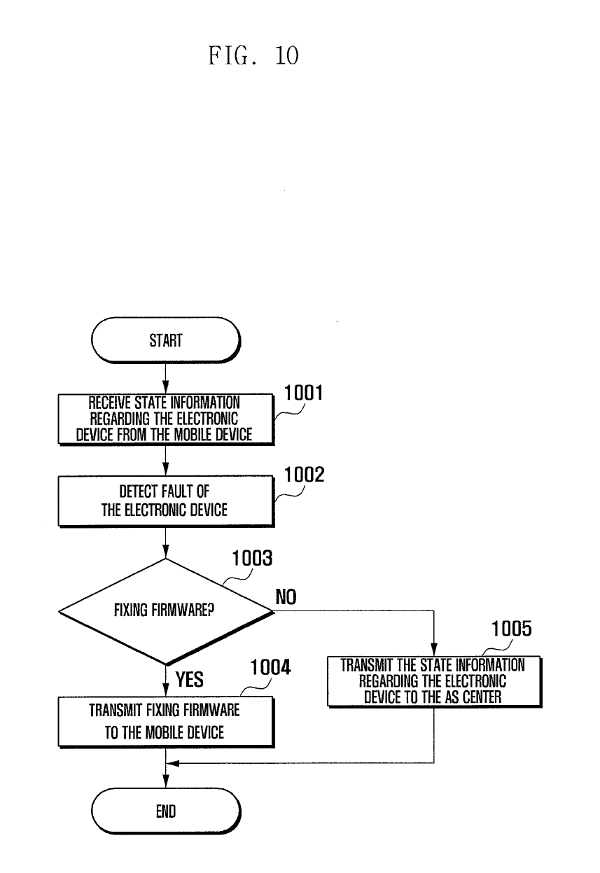

FIG. 10 is a flowchart that describes operations of a cloud server in a system for providing AS, according to an exemplary embodiment of the present invention.

The communication unit 410 of the cloud server 400 receives the state information regarding the electronic device 200 from the mobile device 100, and transmits the state information to the malfunction determining unit 420 in step 1001. The malfunction determining unit 420 determines whether the electronic device 200 is faulty, based on the received state information in step 1002. The malfunction determining unit 420 searches for fault information corresponding to the state information from the malfunction information DB 430. The malfunction information DB 430 stores at least one of drive voltage values, GPIO values, etc., in the normal states of electronic devices, respectively. The malfunction determining unit 420 identifies the type of electronic device 200 via the state information transmitted from the mobile device 100. The malfunction determining unit 420 compares the state information regarding the identified type of electronic device with the normal state information regarding the identified type of electronic device, stored in the malfunction information DB 430. When the malfunction determining unit 420 determines that the state information regarding the identified type of electronic device is identical to the normal state information regarding the identified type of electronic device, the malfunction determining unit 420 concludes that the electronic device does not have a hardware fault. In contrast, when the malfunction determining unit 420 determines that the state information regarding the identified type of electronic device is not identical to the normal state information regarding the identified type of electronic device, the malfunction determining unit 420 concludes that the electronic device has a hardware fault.

The malfunction determining unit 420 detects at least one of a debugging log and an error code in the state information regarding the electronic device 200, and concludes that the electronic device 200 has a software fault. When there is at least one of an error in the state information and error correction failure information included in a debugging log, the malfunction determining unit 420 concludes that the electronic device has a software fault.

When the malfunction determining unit 420 determines that the electronic device 200 has a software fault, the malfunction determining unit 420 transmits the fault information regarding the electronic device 200, such as error code, error information, etc., to the fault fixing firmware managing unit 440. Likewise, when the malfunction determining unit 420 determines that the electronic device 200 has a hardware fault, the malfunction determining unit 420 transmits the fault information, such as at least one of a voltage value, a GPIO value, etc., to the AS center 500, via the communication unit 410.

In an exemplary embodiment of the present invention, when the malfunction determining unit 420 determines that the electronic device 200 has no faults with its hardware and software, the malfunction determining unit 420 transmits a message indicating that no faults occurred to the mobile device 100 via the communication unit 410.

After a determination is made as to whether the electronic device 200 is faulty at step 1002, the fault fixing firmware managing unit 440 determines whether the cloud server 400 has firmware for fixing the faulty state of the electronic device 200 in step 1003. The fault fixing firmware managing unit 440 detects the fault information regarding the electronic device 200 transmitted from the malfunction determining unit 420, and determines whether firmware for fixing a corresponding fault is stored in the fault firmware fixing DB 450. When the fault fixing firmware managing unit 440 determines that firmware for fixing a corresponding fault is stored in the fault firmware fixing DB 450 at step 1003, the fault fixing firmware managing unit 440 loads the firmware from the fault firmware fixing DB 450 and transmits the firmware to the mobile device 100 via the communication unit 410 in step 1004. In contrast, when the fault fixing firmware managing unit 440 determines that firmware for fixing a corresponding fault is not stored in the fault firmware fixing DB 450 at step 1003, the fault fixing firmware managing unit 440 transmits the fault information to the AS center 500 via the communication unit 410 in step 1005. The fault information transmitted may include at least one of an error code, error information, etc.

In another exemplary embodiment of the present invention, the communication unit 410 may receive the fault information regarding the electronic device 200 from the AS center 500. In that case, the communication unit 410 transmits the fault information to the fault fixing firmware managing unit 440. The fault fixing firmware managing unit 440 determines whether fixing firmware corresponding to the received fault information is stored in the fault fixing firmware DB 450. When the fault fixing firmware managing unit 440 determines that fault fixing firmware is stored in the fault fixing firmware DB 450, the fault fixing firmware managing unit 440 transmits the fault fixing firmware to the mobile device 100 via the communication unit 410. In contrast, when the fault fixing firmware managing unit 440 determines that fixing firmware is not stored in the fault fixing firmware DB 450, the fault fixing firmware managing unit 440 transmits a message indicating that the cloud server 400 does not have fixing firmware to the AS center 500, via the communication unit 410.

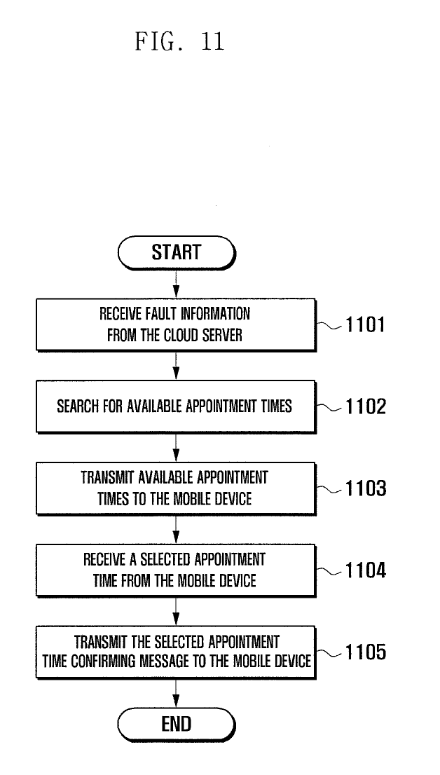

FIG. 11 is a flowchart that describes operations of an AS center in a system for providing AS, according to an exemplary embodiment of the present invention.

The communication unit 510 of the AS center 500 receives the fault information regarding the electronic device 200 from the cloud server 400 in step 1101. The fault information received may include at least one of a voltage value, a GPIO value, etc., in an abnormal state, or an error code. The AS request receiving unit 540 searches for available service appointment times from the AS request receiving DB 550 in step 1102, and transmits a message including the times to the mobile device 100 via the communication unit 510 in step 1103. The mobile device 100 transmits one of the available service appointment times, selected by the user, as a selected service appointment time, to the AS center 500. When the communication unit 510 receives the selected service appointment time from the mobile device 100 in step 1104, the AS request receiving unit 540 registers the selected service appointment time in the AS request receiving DB 550 and transmits a message that a service appointment has been made to the mobile device 100 via the communication unit 510 in step 1105.

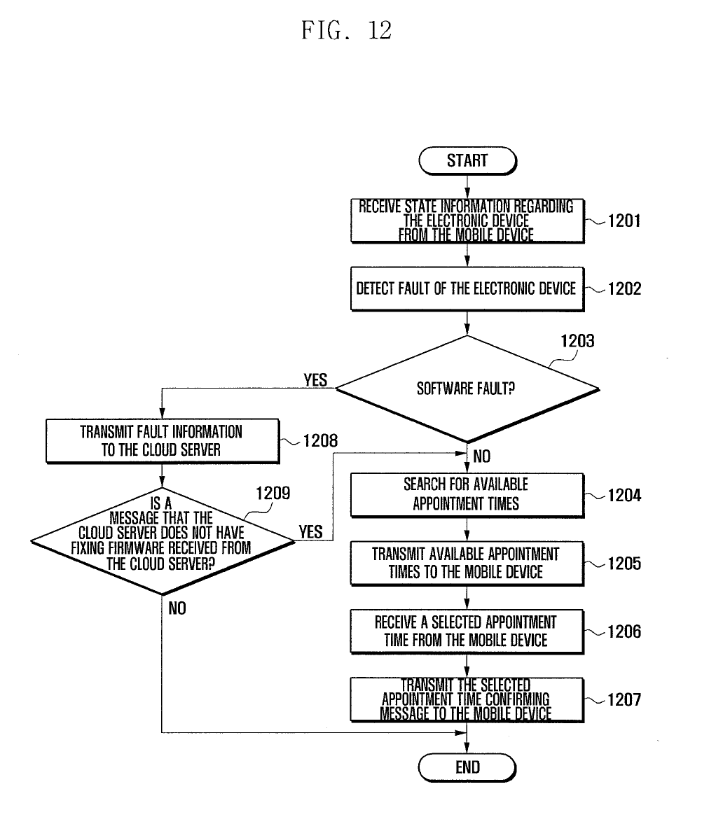

FIG. 12 is a flowchart that describes operations of an AS center in a system for providing AS, according to an exemplary embodiment of the present invention.

The communication unit 510 of the AS center 500 receives the state information regarding the electronic device 200 from the mobile device 100, and transmits the state information to the malfunction determining unit 520 in step 1201. The malfunction determining unit 520 determines whether the electronic device 200 is faulty, based on the state information transmitted from the mobile device 100 in step 1202. The malfunction determining unit 520 searches for fault information corresponding to the state information from the malfunction information DB 530. The malfunction information DB 530 may store at least one of drive voltage values, GPIO values, etc., corresponding to the normal states of electronic devices, respectively. The malfunction determining unit 520 identifies the type of electronic device via the information transmitted from the mobile device 100. The malfunction determining unit 520 compares the state information regarding the identified type of electronic device with the normal state information regarding the identified type of electronic device, stored in the malfunction information DB 530. When the malfunction determining unit 520 determines that the state information regarding the identified type of electronic device is identical to the normal state information regarding the identified type of electronic device, the malfunction determining unit 520 concludes that the electronic device does not have a hardware fault. In contrast, when the malfunction determining unit 520 determines that the state information regarding the identified type of electronic device is not identical to the normal state information regarding the identified type of electronic device, the malfunction determining unit 520 concludes that the electronic device has a hardware fault.

The malfunction determining unit 520 detects at least one of a debugging log and an error code in the state information regarding the electronic device 200, and concludes that the electronic device 200 has a software fault. When there is at least one of an error code in the state information and error correction failure information included in a debugging log, the malfunction determining unit 520 concludes that the electronic device has a software fault.

The malfunction determining unit 520 determines whether the electronic device 200 has a software fault in step 1203. The malfunction determining unit 520 detects at least one of a debugging log and an error code in the state information regarding the electronic device 200, and concludes that the electronic device 200 has a software fault. When there is at least one of an error code in the state information and error correction failure information included in a debugging log, the malfunction determining unit 520 concludes that the electronic device has a software fault. When the malfunction determining unit 520 determines that the electronic device 200 has no faults with its hardware and software, the malfunction determining unit 520 transmits a message indicating that the electronic device 200 is not faulty to the mobile device 100 via the communication unit 510. When the malfunction determining unit 520 determines that the electronic device does not have a software fault but has a hardware fault, the malfunction determining unit 520 transmits the fault information to the AS request receiving unit 540.

The AS request receiving unit 540 searches for available service appointment times from the AS request receiving DB 550 in step 1204, and transmits a message including the times to the mobile device 100 via the communication unit 510 in step 1205. The mobile device 100 transmits one of the available service appointment times, selected by the user, as a selected service appointment time, to the AS center 500. The AS request receiving unit 540 receives the selected service appointment time from the mobile device 100 via the communication unit 510 in step 1206. The AS request receiving unit 540 registers the selected service appointment time in the AS request receiving DB 550, and transmits a message confirming that a service appointment has been made to the mobile device 100 via the communication unit 510 in step 1207.

In contrast, when the malfunction determining unit 520 determines that the electronic device 200 has a software fault at step 1203, the malfunction determining unit 520 transmits the fault information regarding the electronic device 200, such as at least one of an error code and error information, to the cloud server 400 in step 1208. The cloud server 400 determines whether it has fault fixing firmware. When the cloud server 400 determines that it has fixing firmware, the cloud server 400 transmits the firmware to the mobile device 100. In contrast, when the cloud server 400 determines that it does not have fixing firmware, it transmits a message notifying that the cloud server 400 does not have fixing firmware to the AS center 500. The communication unit 510 determines whether it receives the message from the cloud server 400 in step 1209. When the communication unit 510 receives the message from the cloud server 400 at step 1209, the communication unit 510 transfers the message to the AS request receiving unit 540. The AS request receiving unit 540 proceeds to step 1204.

As described above, the system and method according to exemplary embodiments of the present invention can allow users to request an after-sales service for an electronic device, by making the mobile device approach or touch the electronic device. When an electronic device is faulty and, when the fault is caused by software, the user downloads an application program onto their mobile device to resolve the problem and installs fault fixing firmware on the electronic device. This means the user doesn't need to take the faulty electronic device to a service center or waste time waiting for a service appointment. In addition, the service center doesn't receive a user's oral explanation regarding the faulty electronic device, but information regarding the malfunctioning of electronic devices. That is, the service center can acquire objective information regarding the malfunctioning of the electronic device and, accordingly, detect the precise states. Therefore, the service center can provide precise service for the user's electronic device.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for providing an After-sales Service (AS) to an electronic device, the method comprising:
receiving, by a mobile device, state information regarding the electronic device from the electronic device;
transmitting, by the mobile device, the state information to a cloud server;
determining, by the cloud server, whether the electronic device is experiencing a fault, via the received state information;
determining, by the cloud server, whether the cloud server has fault fixing firmware for fixing the fault;
transmitting, when the cloud server has the fault fixing firmware, the fault fixing firmware to the mobile device;
transmitting, by the mobile device, the fault fixing firmware to the electronic device; and
installing the fault fixing firmware in the electronic device.

2. The method of claim 1, further comprising:
transmitting, when the cloud server does not have the fault fixing firmware, information regarding the fault of the electronic device to an AS center;
transmitting available service appointment times from the AS center to the mobile device;
transmitting, when a user selects a service appointment time from among the available service appointment times, the selected service appointment time from the mobile device to the AS center; and
transmitting a message confirming that a service appointment has been made from the AS center to the mobile device.

3. The method of claim 1, wherein the receiving of the state information regarding the electronic device comprises:
executing an electronic device AS request application in the mobile device;
requesting, by the mobile device, the state information regarding from the electronic device, via Near Field Communication (NFC);
collecting the state information in the electronic device; and
transmitting the collected state information regarding the electronic device from the electronic device to the mobile device via NFC.

4. The method of claim 1, wherein the state information regarding the electronic device comprises at least one of a drive voltage value, a General Purpose Input/Output (GPIO) value, a debugging log and an error code.

5. The method of claim 1, further comprising:
transmitting, by the cloud server, a message including fixing information according to the fault to the mobile device.

6. A method for providing an After-sales Service (AS) to an electronic device, the method comprising:
receiving, by a mobile device, state information from the electronic device;
transmitting, by the mobile device, the state information regarding the electronic device to an AS center;
determining, by the AS center, whether the electronic device is experiencing a fault, via the received state information;
determining, by the AS center, whether the electronic device has a software fault;
transmitting, when the electronic device has a software fault, information regarding the fault to a cloud server;
determining, by the cloud server, whether the cloud server has fault fixing firmware for fixing the fault;
transmitting, when the cloud server has fault fixing firmware, the fault fixing firmware to the mobile device;
transmitting, by the mobile device, the fault fixing firmware to the electronic device; and
installing the fault fixing firmware in the electronic device.

7. The method of claim 6, further comprising:
transmitting, when the electronic device does not have the software fault, available service appointment times from the AS center to the mobile device;
transmitting, when a user selects a service appointment time from among the available service appointment times, the selected service appointment time from the mobile device to the AS center; and
transmitting a message confirming that a service appointment has been made from the AS center to the mobile device.

8. The method of claim 6, further comprising:
notifying the AS center that the cloud server does not have the fault fixing firmware;
transmitting available service appointment times from the AS center to the mobile device;
transmitting, when a user selects a service appointment time from among the available appointment times, the selected appointment time from the mobile device to the AS center; and
transmitting a message confirming that a service appointment has been made from the AS center to the mobile device.

9. The method of claim 6, wherein the state information regarding the electronic device comprises at least one of a drive voltage value, a General Purpose Input/Output (GPIO) value, a debugging log and an error code.

10. The method of claim 6, further comprising:
transmitting a message, including fixing information according to the fault, from the cloud server to the mobile device.

11. An After-sales Service (AS) providing system, the system comprising:
an electronic device with a short-range communication module;
a mobile device; and
a cloud server,
wherein the electronic device communicates with the mobile device via short-range communication, collects state information, transmits the collected state information to the mobile device according to a request of the mobile device, receives fault fixing firmware from the mobile device, and installs the fault fixing firmware,
wherein the mobile device receives the state information regarding the electronic device from the electronic device, transmits the state information to the cloud server, receives the fault fixing firmware from the cloud server, and transmits the received fault fixing firmware to the electronic device, and
wherein the cloud server determines whether the electronic device is experience a fault, via the state information regarding the electronic device, determines whether the cloud server has the fault fixing firmware for fixing the fault of the electronic device, and transmits the fault fixing firmware to the mobile device.

12. The system of claim 11, further comprising:
an AS center,
wherein, when the cloud server determines that the cloud server does not have fault fixing firmware for fixing the fault of the electronic device, the cloud server transmits information regarding the fault to the AS center,
wherein, when the AS center receives the information regarding the fault of the electronic device from the cloud server, the AS center transmits available service appointment times to the mobile device, and
wherein, when the AS center receives a service appointment time selected by the user from among the available appointment times, the AS center transmits a message confirming that a service appointment has been made to the mobile device.

13. A method for providing an electronic device After-sales Service (AS) adapted to a mobile device, the method comprising:
receiving state information regarding the electronic device;
transmitting the received state information from the mobile device to a cloud server;
receiving fault fixing firmware from the cloud server, and displaying a message notifying that the fault fixing firmware has been received;
receiving a user's instruction for transmitting the fault fixing firmware and determining whether the mobile device can communicate with the electronic device; and
transmitting, when the mobile device can communicate with the electronic device, the fault fixing firmware to the electronic device.

14. The method of claim 13, further comprising:
displaying a transmission failure message when the mobile device cannot communicate with the electronic device.

15. The method of claim 13, further comprising:
transmitting the received state information to an AS center;
receiving available service appointment times from the AS center, and displaying the available service appointment times;
transmitting an available service appointment time selected by a user from among the available appointment times, to the AS center; and
receiving a message confirming that a service appointment has been made from the AS center.
